(19) United States
(12) Patent Application Publication
(10) Pub. No.: US 2005/0236786 A1
(43) Pub. Date: Oct. 27, 2005

(54) Apparatus for transporting articles and method of use therefor

(76) Inventor: Mac Bryan, Lawrenceville, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/833,191

(22) Filed: Apr. 27, 2004

(51) Int. Cl. B62B 9/04

(52) U.S. Cl. 280/28.12

(57) ABSTRACT

An article transporting apparatus having a sled base with a cage basket removably secured thereto, wherein articles such as captured/harvested game may be placed and retained within the basket, and subsequently towed to a designated area via an all-terrain vehicle. The removable basket may further be utilized to hang and retain camp objects thereon, thereby maintaining same at an above-ground level.

### TECHNICAL FIELD

The present invention relates generally to transportation devices, and more specifically to an apparatus having a basket removably secured thereto. The present invention is particularly advantageous for, although not strictly limited to, enabling the convenient and rapid access to, and/or transport of, harvested game and other articles, such as hunting accessories and/or clothing.

### BACKGROUND OF THE INVENTION

Hunting game often requires various hunting implements and devices to enable a hunter to effectively seek, take and recover prey. Among the most important of such devices is a transportation device for returning game to the hunter's camp or other location suitable for dressing.

Consequently, many devices have been designed for the purpose of transporting harvested game. Some such devices utilize sled-like runners having containing devices mounted thereon, whereas other devices are suitable for towing game. However, once game has been acquired and transported, it is often difficult to remove the captured game from the transporting device. As such, many hunters must resort to lifting the game over the edge of a containment area, and therefore often subject themselves to bodily or muscular strain and/or injury.

Typically hunters must carry a multitude of hunting and camping equipment components to carry out a wide variety of tasks. As such, most hunters often attempt to utilize single devices for multiple uses, in an effort to minimize the overall load on him/herself. However, most currently available devices have a defined use or purpose that does not permit flexibility of application of same.

Accordingly, because hunters must carry a plurality of such devices, and due to the need for portability, it is desirable that devices have more than a single purpose. Furthermore, carrying or transporting a large number of devices tends to add to the weight and volume that a hunter must transport, restricts a hunter to open areas, and/or retards the hunter's progress through confined areas, thereby slowing down the hunter and reducing the time available for hunting prey. Additionally, it may be necessary for a hunter to make a number of trips to transport all the necessary items for hunting and camping. Such trips reduce the time available to the hunter, are tiring, and cause disruption of the environment in which prey is to be hunted.

In addition, once in a camp location, it is desirable that a hunter have the ability to keep clothing, food and utensils at an above-ground level, as it is disadvantageous for a hunter to leave scent or other evidence of his prior presence that might be identified by, and thus frighten game. However, placing clothing over natural objects, such as trees and rocks, will cause the clothing to become dirtied with sap or dirt, and/or infested with insects, and may leave the scent of the hunter behind. It is thus desirable to have a device with clean surfaces that can be utilized to support clothing. It is even more desirable if such a device can be utilized to maintain other objects such as utensils off of the ground so that such objects remain clean and away from possible insect infestation.

Even more desirable would be the ability to utilize such a device for other purposes, such as transporting objects, when not in use for supporting camp implements, food and clothing. Unfortunately, presently available devices lack the combination of a transportation device with a supporting apparatus for camp equipment.

Therefore, it is readily apparent that there is a need for an apparatus and method that permits a hunter to retrieve harvested game, easily transport the game to an area where the game may be dressed, and easily remove the game from the transport device.

There is a further need for such an apparatus that permits a hunter to easily contain and transport personal accessories and/or hunting accessories, thereby providing a hunter with ready access thereto when in pursuit of game. There is still a further need for such an apparatus that enables a hunter to travel while transporting a minimal number of equipment components, and it is often necessary that hunting implements be utilized for more than one purpose so as to reduce weight and/or load on the hunter.

Moreover, it is desirable to have a device that can support clothing, food, and/or other devices utilized by a hunter, such as cookware, knives, utensils and the like, and thus maintain such food, clothing and devices at an above-ground level.

As will be more fully detailed hereinbelow, it is to the provision of such an apparatus and method that the present invention is directed.

### BRIEF SUMMARY OF THE INVENTION

Briefly described, in a preferred embodiment, the present invention overcomes the above-mentioned disadvantages and meets the recognized need for such a device by providing a game transporting apparatus having a sled base with a cage basket removably secured thereto. Captured game may be placed and retained within the basket, and subsequently towed to a designated area via an all-terrain vehicle, or the like. Additionally, the basket may further be utilized to hang and retain camp objects thereon, thereby maintaining same at an above-ground level.

According to its major aspects and broadly stated, the present invention in its preferred form is an apparatus for transporting articles and method of use therefor, comprising, in general, a base with runners, wherein the base includes a basket removably secured thereto, and wherein the runners permit the sled device to be towed across ground surfaces.

More specifically, the present invention is an article transporting apparatus having a sled base and a basket carried by the sled base. The cage-like basket forms a rectangular shape with four sides and an open top and bottom. The sled base forms a fifth side comprising the bottom of the basket when the basket is secured to the base by quick-release retaining devices. The basket is removably attached to the sled base thereby facilitating extraction of articles therefrom, such as, for exemplary purposes only, harvested game. Additionally, items may be selectively stored or carried on the base within the basket.

The sled base has runners and a platform, thereby forming an apparatus that can freely move under tow across ground surfaces. A tie bar extends between the two long sides of the basket thereby tying the two sides together and preventing expansion away from one another.

The front end of sled base comprises a hook eye through which a rope may be securely tied. The rope may then be secured to all-terrain vehicle, for transporting the harvested game to a desired location for dressing.

The present invention further contemplates that the basket may optionally provide the hunter with additional uses other than for maintaining the harvested game supported upon the base. Accordingly, upon removal of the quick-release retaining devices, the basket can be lifted off the sled base allowing unfettered access to the articles transported thereon. The removed basket can then be utilized to support the accouterments of a camp, such as clothing, cooking utensils, dressing knives, and the like, thereby keeping such articles off the ground and readily available, and further preventing insect infestation and/or soilage of same.

Accordingly, a feature and advantage of the present invention is its ability to transport harvested game from remote areas to an area where the game may be dressed.

Another feature and advantage of the present invention is its ability to facilitate extraction of the captured/harvested game from the basket without undue effort.

Still another feature and advantage of the present invention is its ability to provide an above-ground support for clothing and other implements carried and utilized by a hunter.

Yet another feature and advantage of the present invention is its ability to travel across rough terrain.

Yet still another feature and advantage of the present invention is its ability to collapse to reduce the space required for transporting the device in a hunter's field vehicle to/from a hunting area.

Yet a further feature and advantage of the present invention is its ease of use.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a perspective view of an apparatus for transporting articles according to a preferred embodiment of the present invention;

FIG. 2A is a detail drawing of a towing eye of an apparatus for transporting articles according to a preferred embodiment of the present invention;

FIG. 2B is a detail drawing of a fastener component of an apparatus for transporting articles according to a preferred embodiment of the present invention; and

FIG. 3 is a perspective view of a basket portion of an apparatus for transporting articles according to a preferred embodiment of the present invention.

### DETAILED DESCRIPTION OF THE PREFERRED AND ALTERNATIVE EMBODIMENTS

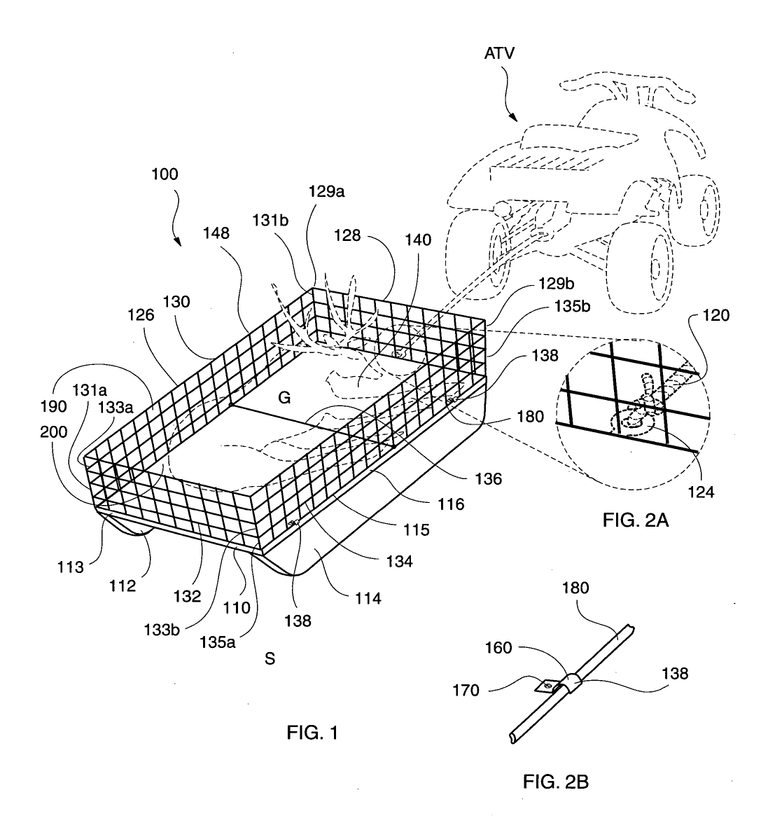

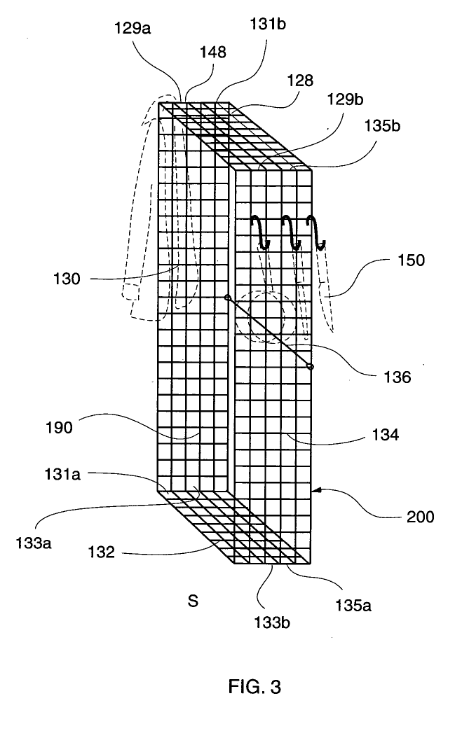

In describing the preferred and selected alternate embodiments of the present invention, as illustrated in FIGS. 1-2, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIG. 1, the present invention in a preferred embodiment is a transporting apparatus 100, preferably comprising sled base 110 and cage basket 126. Sled base 110 preferably includes first runner 112, second runner 114 and platform 116, wherein first runner 112 is preferably fixably attached to first side 113 of platform 116, and wherein second runner 114 is preferably fixably attached to second side 115 of platform 116, thereby forming an apparatus that can preferably freely move under tow across ground surfaces S.

Basket 126 preferably has a cage-like structure and is preferably removably secured to sled base 110. Cage basket 126 preferably has front end 128, first side 130, rear end 132 and second side 134. Front end 128 preferably has first edge 129a and second edge 129b. Rear end 132 preferably has first edge 133a and second edge 133b. First side 130 preferably has first edge 131a and second edge 131b. Second side 134 preferably has first edge 135a and second edge 135b. First end 128, first side 130, rear end 132 and second side 134 are preferably joined at the ends thereof, wherein first edge 129a is preferably in communication with second edge 131b, second edge 129b is preferably in communication with second edge 135b, first edge 135a is preferably in communication with second edge 133b, and first edge 131a is preferably in communication with first edge 133a. It will be recognized by those skilled in the art that edges 129a, 129b, 131a, 131b, 133a, 133b, 135a and 135b can be fixably attached, pivotally attached and/or removably secured to each other.

First end 128, first side 130, rear end 132 and second side 134 preferably form a rectangular construction 148, thereby preferably defining storage area 140. Tie bar 136 preferably extends between first side 130 and second side 134 of cage basket 126, thereby preferably restraining first side 130 and second side 134 from expansion away from one another. Cage basket 126 preferably has open top 190 and open bottom 200.

Cage basket 126 is preferably carried by sled base 110 and is preferably removably affixed thereto via fasteners 138, wherein fasteners 138 preferably permit rapid installation and/or removal of cage basket 126 from sled base 110. Fasteners 138 preferably comprise curved metal bar 160 secured on one end thereof to sled base 110 via screw 170. Curved metal bar 160 is preferably rotated about screw 170 and preferably frictionally moved over wire edges 180 of cage basket 126, thereby holding cage basket 126 on sled base 110. Although fasteners 138 are preferably in the form of curved metal bar 160, it should be recognized that other suitable quick-release retaining clips may be utilized, such as, for exemplary purposes only, latches, clips, clamps, ratchets, and toggle devices.

Preferably disposed on front end 128 of sled base 110 is towing eye 124, wherein towing eye 124 is preferably dimensioned to receive rope 120 removably secured therethrough. Rope 120 is preferably secured to all-terrain vehicle ATV, or the like, whereby transporting apparatus 100 is thereby preferably pulled to a desired location by all-terrain vehicle ATV. In an alternate embodiment, a built-in towing cable, latches, clips, clamps, winch and/or ratchet mechanisms could be utilized instead of the towing eye 124 and rope 120.

In operation, harvested game G, or other selected articles, are preferably placed within cage basket 126 of apparatus 100. Rope 120 is preferably secured to towing eye 124 and to all-terrain vehicle ATV. Harvested game G is then preferably towed to a suitable location where cage basket 126 is preferably removed fully or partially from sled base 110, thereby preferably providing ready access to harvested game G and preferably facilitating the removal of harvested game G thereon.

Cage basket 126 may also preferably selectively be utilized as a support device onto which a variety of hunting tools and equipment may be attached, as best shown in FIG. 2. In such application, cage basket 126 is preferably placed on ground surface S, wherein front end 128 of cage basket 126 preferably lies proximate ground surface S. Thereafter, a hunter preferably utilizes cage basket 126 to support utensils 150, such as those needed to dress harvested game G, or for cooking, by hanging utensils 150 to first side 130, second side 134 or rear end 132. Cage basket 126 can further preferably be utilized to support excess clothing and/or other personal articles. It should be clear to one skilled in the art that cage basket 126 can be stood on either front end 128 or rear end 132 for greatest height, or alternately on first side 130 or second side 134 for a lower profile, depending on how far off the ground the hunter desires to place and retain his utensils or other camping implements.

It is contemplated in an alternate embodiment of the present invention that a single runner could be fixably attached to the base.

It is further contemplated in an alternate embodiment of the present invention that basket 126 could have solid sides.

It is still further contemplated that basket 126 could have fold-down sidewalls.

It is yet still further contemplated that basket 126 could have sidewalls comprised of mesh.

It is also contemplated in an alternate embodiment of the present invention that basket 126 could have tie bars between ends 128, 132 and/or between sides 130, 134.

It is yet further contemplated that the present invention could be collapsible for easy storage and/or carrying, wherein ends 128, 132 and sides 130, 134 could be pivotally attached, and wherein ends 128, 132 and sides 130, 134 could form a flat shape when collapsed.

It is envisioned in an alternate embodiment of the present invention that other assemblies could be utilized to move apparatus 100 across a ground surface can be utilized, such as, for exemplary purposes only, wheel assemblies, skis or ice blades.

It is yet further contemplated in an alternate embodiment of the present invention that apparatus 100 could comprises a motorized mechanism, wherein the motorized mechanism drives tracks, runners or wheels.

It is still yet further contemplated in alternate embodiment of the present invention that a mesh bag could be utilized in lieu of cage basket 126 by securing the mesh bag to sled base 110.

In another alternate embodiment of the present invention, cage basket 126 could comprise any selected shape, such as circular, oval, elliptical, hexagonal, octagonal or any other polygonal shape.

In yet another alternate embodiment of the present invention, it is envisioned that tie bar 136 could be removed to permit cage basket 126 to collapse to a flat shape.

In still yet another embodiment of the present invention, it is envisioned that cage basket 126 could have a floor in lieu of, or in addition to, tie bar 136. Such a floor could be hinged and openable upon lifting rectangular construction 148 defined by sides 130, 134 and ends 128, 132 of cage basket 126. In such fashion, cage basket 126 can be swung off the base, while leaving the floor still retained thereon, so that a hunter can work with the articles transported on apparatus 100.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely numbering or listing the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

1. An article transporting device comprising:
a base having a flat supporting surface for receiving the article for transport, and comprising means for transporting said base across a selected surface; and
a four-sided cage basket removably secured to said flat supporting surface of said base, wherein said four-sided cage basket bounds the peripheral edges of said flat support surface of said base, defining a confined area on said flat support surface of said base, and wherein said four-sided cage basket is adapted to stand upright, independent of said base, wherein each side of said four-sided cage basket is adapted to function as a support stand for said four-sided cage basket.

2. The article transporting device of claim 1, wherein said at least one means for transporting comprises at least one sled runner.

3. The article transporting device of claim 1, wherein said means for transporting comprises at least one wheel.

4. (canceled)

5. (canceled)

6. The article transporting device of claim 1, wherein said cage basket is adapted to collapse.

7. (canceled)

8. (canceled)

9. The article transporting device of claim 1, wherein said cage basket further comprises at least one tie bar.

10. The article transporting device of claim 9, wherein said at least one tie bar is adapted to provide said cage basket with enhanced structural rigidity.

11. The article transporting device of claim 9, wherein said at least one tie bar is removably securable to said at least one side.

12. The article transporting device of claim 1, wherein said base further includes at least one quick-release retaining clip, wherein said cage basket is retained on said base via said at least one quick-release retaining clip.

13. The article transporting device of claim 1, further comprising a towing eye to facilitate removable attachment of a means for towing thereto.

14. The article transporting device of claim 1, further comprising a means for towing selected from the group consisting of a built-in towing cable, latches, clips, clamps, winches, ratchet mechanisms, and combinations thereof.

15. A method of transporting articles, said method comprising the steps of:
a. obtaining an article transporting device having a base and a removably-secured cage basket thereon, wherein said cage basket defines a peripheral boundary of said base, wherein said base comprises at least one sled runner attached thereto, and wherein said cage basket further comprises at least one tie bar adapted to provide said cage basket with structural rigidity;
b. placing the articles within said cage basket; and
c. towing said transporting device to a selected location.

16. The method of transporting articles of claim 15, wherein said cage basket is collapsible.

17. The method of transporting articles of claim 15, said method further comprising the steps of:
d. removing said cage basket from said base; and
e. placing said cage basket in a freestanding position supported on a first side and hanging an item on any one of the remaining three sides.

18. (canceled)

19. The method of transporting articles of claim 17, said method further comprising the steps of:
d′. removing said cage basket;
e′. resting said cage basket on a ground surface; and
f′. removably securing selected articles to said cage basket.

20. A device for hauling harvested game comprising:
a cage basket having pivotally-attached sides, wherein said pivotally-attached sides are adapted to allow said cage basket to collapse;
a sled base comprising a towing eye for removably securing a tow rope thereto; and
at least one quick-release fastener on said sled base, wherein said cage basket is removably secured to said sled base via said at least one quick-release fastener.

21. The device of claim 20, wherein said cage basket is adapted to be removed and utilized independently from said sled base.

22. The device of claim 20, wherein said cage basket is adapted to support objects thereon.
